(19) United States
(12) Patent Application Publication
(10) Pub. No.: US 2007/0248373 A1
(43) Pub. Date: Oct. 25, 2007

(54) INSERTING BLANK CELLS IN N-UP PRINTING

(76) Inventor: Ajay K. Vekaria, Pittsford, NY (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/379,399

(22) Filed: Apr. 20, 2006

(51) Int. Cl. G03G 15/00

(52) U.S. Cl. 399/82

(57) ABSTRACT

Embodiments receive a printing command to print a document file. The document file comprises a plurality of document pages, and each of the document pages comprises markings (e.g., textural and/or graphical elements). The embodiments automatically combine a plurality of the document pages on at least one side of a printing sheet (both sides for duplex printing). The embodiments also automatically insert blank pages (blank cells) adjacent each of the document pages on the printing sheet. Thus, with embodiments herein a blank page or cell automatically appears next to each of the document pages on the printing sheet. Then, the embodiments herein can automatically perform the simplex or duplex printing of the printing sheet.

### BACKGROUND

Embodiments herein generally relate to electrostatographic printers and copiers or reproduction machines, and more particularly, concerns inserting blank cells in n-up printing.

As described more fully in U.S. Pat. No. 6,608,978, the complete disclosure of which is incorporated herein by reference, “n-up” printing (printing multiple cells per page) can be performed automatically for different purposes, such as to save paper. Popular print drivers such as the Adobe PostScript driver for Windows 95 offer options to select duplex, and N-Up printing. When used appropriately, these options can save tremendous amounts of paper. This same opportunity also applies to digital copiers that can duplex and N-Up paper originals while copying.

In addition, many conventional systems allow the user to insert blank pages into a print job. However, these systems actually alter the original print file and require substantial user intervention. For example, U.S. Patent Publication 2005/0198558, the complete disclosure of which is incorporated herein by reference, describes that blank pages can be individually added to a scanned document. Similarly,

U.S. Patent Publications 2005/0162689, 2005/0157330, 2004/0194033, the complete disclosures of which are incorporated herein by reference, describe, that the operator can shuffle pages, reverse pages, insert blank pages, trim and shift pages, create bleeds and place multiple pages on a sheet, also known as “n-up” to create proof sets, brochures or pamphlets, etc.

U.S. Patent Publication 2003/0090707, the complete disclosure of which is incorporated herein by reference, describes that the user can delete specific pages from the resulting sequence and/or insert blank pages to force a section to begin on the correct side of a leaf. Similarly U.S. Patent Publication 2003/0056177, the complete disclosure of which is incorporated herein by reference, describes automatically inserting a blank page to always execute a page break or paper change at a chapter break, to increase the user working efficiency and system productivity, and create a high-quality document by preventing human error.

Thus, as shown above, such conventional systems actually alter the original print file and require substantial user intervention. The embodiments described below address this need by providing the ability to insert blank pages without altering the original print file and without requiring substantial user intervention.

### SUMMARY

Embodiments herein include a method, computer program product, graphic user interface, etc. that receives a printing command to print a document file. The document file comprises a plurality of document pages, and each of the document pages comprises markings (e.g., textural and/or graphical elements). The embodiments automatically combine a plurality of the document pages on at least one side of a printing sheet (both sides for duplex printing). The embodiments also automatically insert blank pages (blank cells) adjacent each of the document pages on the printing sheet. Thus, with embodiments herein a blank page or cell automatically appears next to each of the document pages on the printing sheet. Then, the embodiments herein can automatically perform the simplex or duplex printing of the printing sheet.

The printing command comprises one of a plurality of printing options on a printing command page and includes an instruction to perform the inserting of the blank pages or cells. The instruction to perform the inserting of the blank pages is received through a graphic menu item (e.g., graphical button, graphical check box, or graphical icon, etc.). The graphic menu item can be a single command from the user such as only one single click, only one single key stroke, or only one single menu selection, etc. Thus, with just a single menu selection, the user can automatically add a blank page or cell after each document page appearing on the “n-up” printed sheet to allow notes to be taken and comments to be written directly next to the document pages that appear on the printed sheet.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow diagram illustrating embodiments herein;

FIG. 2 is a schematic diagram of different page layouts produced by embodiments herein;

FIG. 3 is a schematic diagram of a menu used by embodiments herein;

FIG. 4 is a flow diagram illustrating embodiments herein; and

FIG. 5 is a schematic diagram of a printing device.

### DETAILED DESCRIPTION

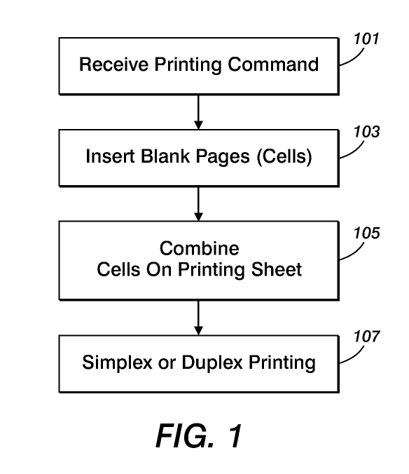

As mentioned above, the embodiments herein the ability to insert blank pages without altering the original print file and without requiring substantial user intervention. Further, embodiments herein insert blanks without utilizing additional paper resources. More specifically, as illustrated in flowchart form in FIG. 1, embodiments herein receive a printing command 101 to print a document file. The document file can comprise a plurality of document pages, and each of the document pages comprises markings (e.g., textural and/or graphical elements). The embodiments automatically insert blank pages (blank cells) adjacent each of the document pages on the printing sheet in item 103. The embodiments automatically combine a plurality of the document pages (cells) on at least one side of a printing sheet (both sides for duplex printing) in item 105. Thus, with embodiments herein a blank page or cell automatically appears next to each of the document pages on the printing sheet. Then, the embodiments herein can automatically perform the simplex or duplex printing (item 107) of the printing sheet.

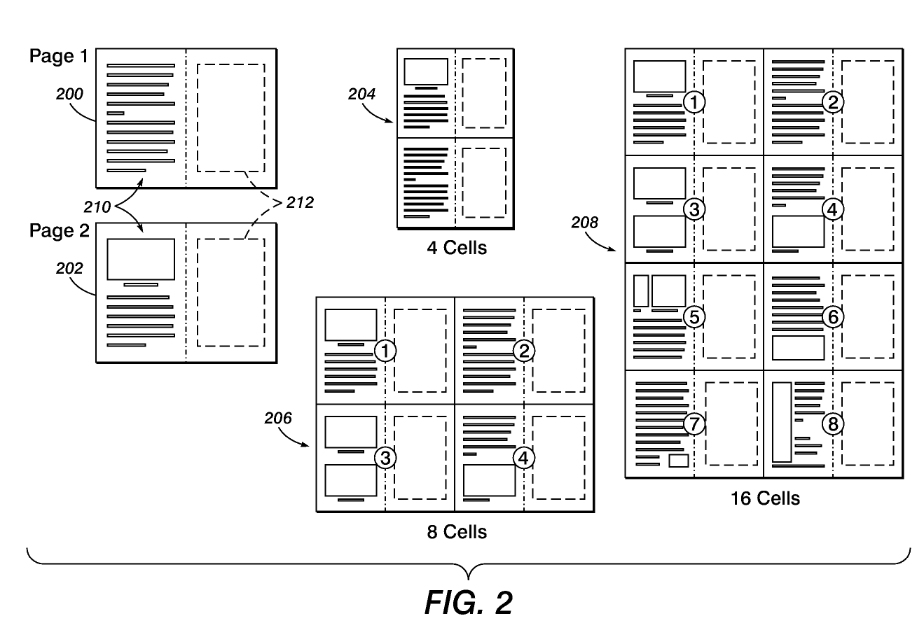

Thus, with just a single menu selection, the user can automatically add a blank page or cell after each document page appearing on the “n-up” printed sheet to allow notes to be taken and comments to be written directly next to the document pages that appear on the printed sheet. More specifically, as shown in FIG. 2, the embodiments herein are adapted to handle many page and cell layouts. For example, item 200 represents a single printing sheet having a text or an image 210 thereon, with a blank cell or page 212 adjacent the text or image 210. The text or image cell 210 shown in item 200 is one of the document pages within the document file associated with printing command, while the blank cell 212 is added by embodiments herein. The blank cell is not added to the document file, but is only supplied to the printing device. That is, embodiments herein do not alter the document file, but instead merely alter the commands to the printing device.

When preparing the document using some form of document preparation application (word processor, presentation software, image processing software etc.) the user would only observe pages of the text or image cells 210. For nomenclature convenience, the pages of text or images produced by the document preparation application are sometimes referred to herein as document pages. To the contrary, the actual items produced by the printer are referred to herein as printing sheets The document pages are distinguished from the printing sheets because the printing sheets include the blank pages or cells that are added by embodiments herein.

Item 202 represents another printing sheet that also includes a text or image cell 210 and a blank cell or page 212. The text or image cell 210 in the printing sheet 202 could merely be the next document page within a given document file that follows the document page illustrated in item 200. In addition, the text or image cell 210 within printing sheet 202 could comprise a different format (single-column text vs. two-column text, etc.) than the text or image cell 210 illustrated in printing sheet 200.

Items 200-202 illustrate printing sheets having two cells each. Item 204 represents a printing sheet having 4 cells; item 206 represents a printing sheet having 8 cells; and item 208 represents a printing sheet having 16 cells. One ordinarily skilled in the art would understand that the embodiments herein are useful with printing sheets having any number of cells and that the embodiments herein are not limited by the number of cells included within any given printing sheet.

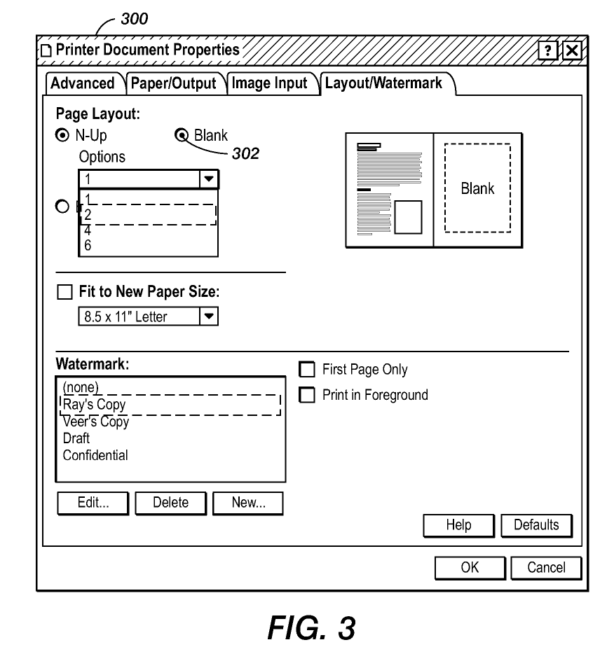

The printing command comprises one of a plurality of printing options on a printing command page and includes an instruction to perform the inserting of the blank pages or cells. The instruction to perform the inserting of the blank pages is received through a graphic menu item (e.g., graphical button, graphical check box, or graphical icon, etc.) such as the one shown in FIG. 3. The graphic menu item can be a single command from the user such as only one single click, only one single key stroke, or only one single menu selection, etc. For example, as shown in FIG. 3, the graphic menu item 300 allows the user to select the “n-up” option and item 302 allows the user to select the option of adding blank pages adjacent each of the original document pages using only one single click, only one single key stroke, or only one single menu selection, etc.

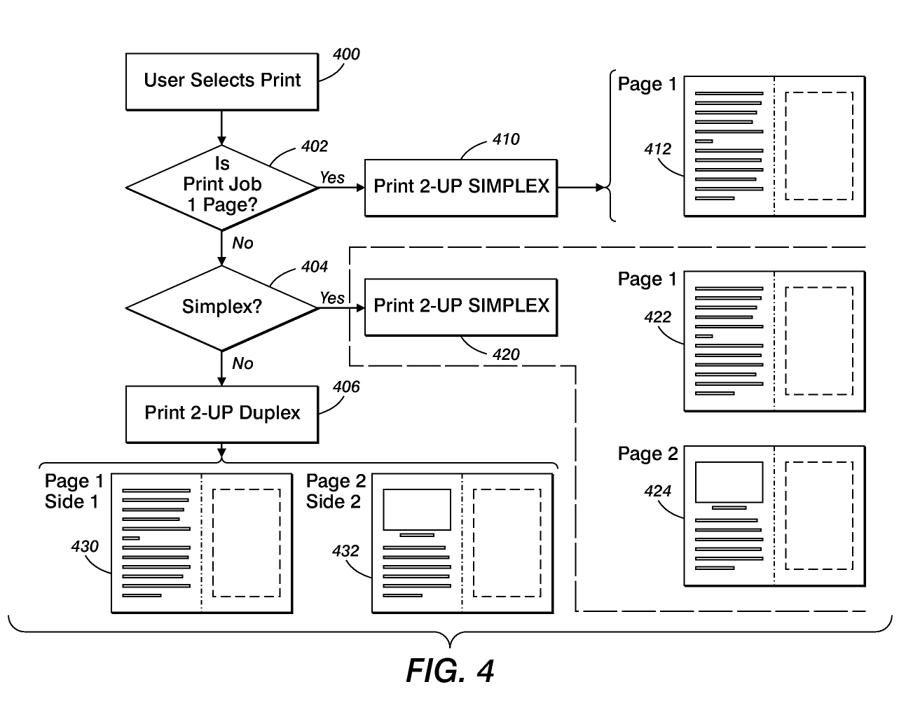

FIG. 4 is a flowchart demonstrating some differences between simplex and duplex printing. More specifically, in item 400, the user selects a printing option thereby providing instructions for printing to be initiated. In item 402, if the print job is only one page, processing proceeds to item 410 whereby a 2-up simplex printing sheet 412 is printed. If the print job is multi-page, processing proceeds to item 404. If the print job is a simplex job, in item 420 a 2-up simplex process is used to print multiple printing sheets 422, 424. To the contrary, if the print job is a duplex job, in item 406 a 2-up duplex process is used to print a first printing sheet 430 on a first side of a sheet of printing media and a second printing sheet 432 on a second side of a sheet of printing media.

While the example shown in FIG. 4 is only a 1 or 2 page example that utilizes only 2-up printing, one ordinarily skilled in the art would understand that the number of document pages could be unlimited, and much greater than just 2. Further, the “n-up” settings can use any value for the variable “n” from the given list 301. That is, the embodiments herein are not limited to the example shown in FIG. 4, as FIG. 4 is merely an example used to illustrate the various features of the embodiments herein.

The word “printer” or “image output terminal” as used herein encompasses any apparatus, such as a digital copier, bookmaking machine, facsimile machine, multi-function machine, etc. which performs a print outputting function for any purpose. The details of printers, printing engines, etc. are well-known by those ordinarily skilled in the art and are discussed in, for example, U.S. Pat. No. 6,032,004, the complete disclosure of which is fully incorporated herein by reference.

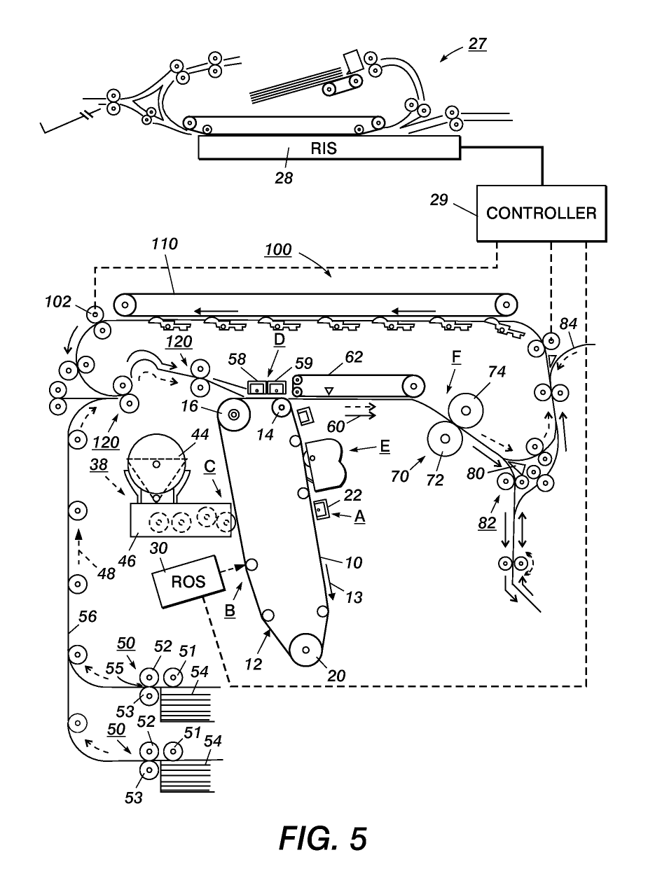

For example, FIG. 5 schematically depicts an electrophotographic printing machine that is similar to one described in U.S. Pat. No. 6,032,004. It will become evident from the following discussion that the present embodiments may be employed in a wide variety of devices and are not specifically limited in its application to the particular embodiment depicted in FIG. 5.

Referring to FIG. 5, an original document is positioned in a document handler 27 on a raster input scanner (RIS) indicated generally by reference numeral 28. The RIS contains document illumination lamps, optics, a mechanical scanning drive and a charge coupled device (CCD) array. The RIS captures the entire original document and converts it to a series of raster scan lines. This information is transmitted to an electronic subsystem (ESS) which controls a raster output scanner (ROS) described below.

FIG. 5 schematically illustrates an electrophotographic printing machine which generally employs a photoconductive belt 10. The photoconductive belt 10 can be made from a photoconductive material coated on a ground layer, which, in turn, can be coated on an anti-curl backing layer. Belt 10 moves in the direction of arrow 13 to advance successive portions sequentially through the various processing stations disposed about the path of movement thereof. Belt 10 can be entrained about stripping roller 14, tensioning roller 16 and drive roller 20. As roller 20 rotates, it advances belt 10 in the direction of arrow 13.

Initially, a portion of the photoconductive surface passes through charging station A. At charging station A, a corona generating device indicated generally by the reference numeral 22 charges the photoconductive belt 10 to a relatively high, substantially uniform potential.

At an exposure station, B, a controller or electronic subsystem (ESS), indicated generally by reference numeral 29, receives the image signals representing the desired output image and processes these signals to convert them to a continuous tone or greyscale rendition of the image which can be transmitted to a modulated output generator, for example the raster output scanner (ROS), indicated generally by reference numeral 30. The ESS 29 can be a self-contained, dedicated minicomputer. The image signals transmitted to ESS 29 may originate from a RIS as described above or from a computer, thereby enabling the electrophotographic printing machine to serve as a remotely located printer for one or more computers. Alternatively, the printer may serve as a dedicated printer for a high-speed computer. The signals from ESS 29, corresponding to the continuous tone image desired to be reproduced by the printing machine, are transmitted to ROS 30. ROS 30 includes a laser with rotating polygon mirror blocks. The ROS will expose the photoconductive belt to record an electrostatic latent image thereon corresponding to the continuous tone image received from ESS 29. As an alternative, ROS 30 may employ a linear array of light emitting diodes (LEDs) arranged to illuminate the charged portion of photoconductive belt 10 on a raster-by-raster basis.

After the electrostatic latent image has been recorded on photoconductive surface 12, belt 10 advances the latent image to a development station, C, where toner, in the form of liquid or dry particles, is electrostatically attracted to the latent image using commonly known techniques. The latent image attracts toner particles from the carrier granules forming a toner powder image thereon. As successive electrostatic latent images are developed, toner particles are depleted from the developer material. A toner particle dispenser, indicated generally by the reference numeral 44, dispenses toner particles into developer housing 46 of developer unit 38.

After the electrostatic latent image is developed, the toner powder image present on belt 10 advances to transfer station D. A print sheet 48 can be advanced to the transfer station, D, by a sheet feeding apparatus, 50. The sheet feeding apparatus 50 includes a nudger roll 51 which feeds the uppermost sheet of stack 54 to nip 55 formed by feed roll 52 and retard roll 53. Feed roll 52 rotates to advance the sheet from stack 54 into vertical transport 56. Vertical transport 56 directs the advancing sheet 48 of support material into the registration transport 120 of the invention herein, described in detail below, past image transfer station D to receive an image from photoreceptor belt 10 in a timed sequence so that the toner powder image formed thereon contacts the advancing sheet 48 at transfer station D. Transfer station D includes a corona generating device 58 which sprays ions onto the back side of sheet 48. This attracts the toner powder image from photoconductive surface 12 to sheet 48. The sheet is then detacked from the photoreceptor by corona generating device 59 which sprays oppositely charged ions onto the back side of sheet 48 to assist in removing the sheet from the photoreceptor. After transfer, sheet 48 continues to move in the direction of arrow 60 by way of belt transport 62 which advances sheet 48 to fusing station F.

Fusing station F includes a fuser assembly indicated generally by the reference numeral 70 which permanently affixes the transferred toner powder image to the copy sheet. The fuser assembly 70 includes a heated fuser roller 72 and a pressure roller 74 with the powder image on the copy sheet contacting fuser roller 72. The pressure roller is cammed against the fuser roller to provide the necessary pressure to fix the toner powder image to the copy sheet. The fuser roll can be internally heated by a quartz lamp (not shown). Release agent, stored in a reservoir (not shown), can be pumped to a metering roll (not shown). A trim blade (not shown) trims off the excess release agent. The release agent transfers to a donor roll (not shown) and then to the fuser roll 72.

The sheet then passes through fuser 70 where the image is permanently fixed or fused to the sheet. After passing through fuser 70, a gate 80 either allows the sheet to move directly via output 84 to a finisher or stacker, or deflects the sheet into the duplex path 100, specifically, first into single sheet inverter 82 here. That is, if the sheet is either a simplex sheet, or a completed duplex sheet having both side one and side two images formed thereon, the sheet will be conveyed via gate 80 directly to output 84. However, if the sheet is being duplexed and is then only printed with a side one image, the gate 80 will be positioned to deflect that sheet into the inverter 82 and into the duplex loop path 100, where that sheet will be inverted and then fed to acceleration nip 102 and belt transports 110, for recirculation back through transfer station D and fuser 70 for receiving and permanently fixing the side two image to the backside of that duplex sheet, before it exits via exit path 84.

After the print sheet is separated from photoconductive surface 12 of belt 10, the residual toner/developer and paper fiber particles adhering to photoconductive surface 12 are removed therefrom at cleaning station E. Cleaning station E includes a rotatably mounted fibrous brush in contact with photoconductive surface 12 to disturb and remove paper fibers and a cleaning blade to remove the nontransferred toner particles. The blade may be configured in either a wiper or doctor position depending on the application. Subsequent to cleaning, a discharge lamp (not shown) floods photoconductive surface 12 with light to dissipate any residual electrostatic charge remaining thereon prior to the charging thereof for the next successive imaging cycle.

The various machine functions are regulated by controller 29 and the methodology shown in FIGS. 1-4, discussed above can be programmed into hardware or software of the controller 29. The controller 29 can be a programmable microprocessor which controls all of the machine functions hereinbefore described. Thus, the controller can comprise a computer-usable data carrier storing instructions that, when executed by a controller (computer), cause the controller to perform the method steps discussed above. The controller provides a comparison count of the copy sheets, the number of documents being recirculated, the number of copy sheets selected by the operator, time delays, jam corrections, etc. The control of all of the exemplary systems heretofore described may be accomplished by conventional control switch inputs from the printing machine consoles selected by the operator. Conventional sheet path sensors or switches may be utilized to keep track of the position of the document and the copy sheets.

The embodiments herein can encompass embodiments that print in color, monochrome, or handle color or monochrome image data. All foregoing embodiments are specifically applicable to electrostatographic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the invention should not be implied or imported from any above example as limitations to any particular order, number, position, size, shape, angle, color, or material.

What is claimed is:

1. A method comprising:
receiving a printing command to print a document file, wherein said document file comprises a plurality of document pages, and wherein each of said document pages comprises markings;
automatically combining a plurality of said document pages on at least one side of a printing sheet;
automatically inserting blank pages adjacent each of said document pages such that a blank page appears next to each of said document pages on said printing sheet; and
automatically performing printing of said printing sheet.

2. The method according to claim 1, wherein said printing command includes an instruction to perform said inserting of said blank pages.

3. The method according to claim 2, wherein said instruction to perform said inserting of said blank pages is received through a graphic menu item.

4. The method according to claim 3, wherein said graphic menu item comprises only one of:
only one single click,
only one single key stroke, and
only one single menu selection.

5. The method according to claim 3, wherein said graphic menu item comprises one of a graphical button, a graphical check box, and a graphical icon.

6. The method according to claim 1, wherein said printing command comprises one of a plurality of printing options on a printing command page.

7. The method according to claim 1, wherein said markings comprise textural and graphical elements.

8. A method comprising:
receiving a printing command to print a document file, wherein said document file comprises a plurality of document pages, and wherein each of said document pages comprises markings;
automatically combining a plurality of said document pages on each side of a printing sheet;
automatically inserting blank pages adjacent each of said document pages such that a blank page appears next to each of said document pages on said printing sheet; and
automatically performing duplex printing of said printing sheet.

9. The method according to claim 8, wherein said printing command includes an instruction to perform said inserting of said blank pages.

10. The method according to claim 9, wherein said instruction to perform said inserting of said blank pages is received through a graphic menu item.

11. The method according to claim 10, wherein said graphic menu item comprises only one of:
only one single click,
only one single key stroke, and
only one single menu selection.

12. The method according to claim 10, wherein said graphic menu item comprises one of a graphical button, a graphical check box, and a graphical icon.

13. The method according to claim 8, wherein said printing command comprises one of a plurality of printing options on a printing command page.

14. The method according to claim 8, wherein said markings comprise textural and graphical elements.

15. A method comprising:
receiving a printing command to print a document file, wherein said document file comprises a plurality of document pages, and wherein each of said document pages comprises markings;
automatically combining a plurality of said document pages on at least one side of a printing sheet, such that said printing sheet is divided into cells;
automatically inserting blank cells adjacent each of cell containing a document page such that one blank cell appears next to each said cell containing a document page on said printing sheet; and
automatically performing printing of said printing sheet.

16. The method according to claim 15, wherein said printing command includes an instruction to perform said inserting of said blank cells.

17. The method according to claim 16, wherein said instruction to perform said inserting of said blank cells is received through a graphic menu item.

18. The method according to claim 17, wherein said graphic menu item comprises only one of:
only one single click,
only one single key stroke, and
only one single menu selection.

19. The method according to claim 17, wherein said graphic menu item comprises one of a graphical button, a graphical check box, and a graphical icon.

20. A computer program product comprising:
a computer-usable data carrier storing instructions that, when executed by a computer, cause the computer to perform a method comprising:
receiving a printing command to print a document file, wherein said document file comprises a plurality of document pages, and wherein each of said document pages comprises markings;
automatically combining a plurality of said document pages on at least one side of a printing sheet;
automatically inserting blank pages adjacent each of said document pages such that a blank page appears next to each of said document pages on said printing sheet; and
automatically performing printing of said printing sheet.
